(19) United States
(12) Patent Application Publication
(10) Pub. No.: US 2026/0065870 A1
(43) Pub. Date: Mar. 5, 2026

(54) METHODS FOR REMOVING COLOR SHIFTS DURING ELECTROPHORETIC DISPLAY UPDATES

(71) Applicant: E INK CORPORATION, Billerica, MA (US)

(72) Inventors: Amit DELIWALA, Andover, MA (US); Jonathan L. ZALESKY, Newton, MA (US)

(21) Appl. No.: 19/312,607

(22) Filed: Aug. 28, 2025

Related U.S. Application Data
(60) Provisional application No. 63/690,170, filed on Sep. 3, 2024.

(51) Int. Cl. G09G 3/34; G02F 1/167; G02F 1/16757; G02F 1/1685

(52) U.S. Cl. CPC G09G 3/344; G02F 1/167; G02F 1/16757; G02F 1/1685; G09G 2300/0814; G09G 2320/0242

(57) ABSTRACT

Methods for using “P” type waveforms to reduce color drift, ghosting, and other transient color shifts. While the method is most useful for regulating white state drift, related techniques can be used to address color state drift in other multi-particle color platforms, as well as in color-filter-array (CFA) electrophoretic displays. The methods help to fix color drift that may accompany partial update methods, i.e., whereby only a portion of the display panel receives update instructions from the controller between a first and a second image.

### RELATED APPLICATIONS

This application claims priority to U.S. Provisional Patent Application No. 63/690,170, filed Sep. 3, 2024. All patents and publications disclosed herein are incorporated by reference in their entireties.

### BACKGROUND

An electrophoretic display (EPD) changes color by modifying the position of a charged colored particle with respect to a light-transmissive viewing surface. Such electrophoretic displays are typically referred to as “electronic paper” or “ePaper” because the resulting display has high contrast and is sunlight-readable, much like ink on paper. In the simplest sense, an electrophoretic display only requires a light-transmissive electrode at the viewing surface, a back electrode, and an electrophoretic medium including one or more types of charged colored particles. If the back electrode includes controllable regions (pixels)—either segmented electrodes or an active matrix of pixel electrodes controlled by transistors—a pattern can be made to appear electronically at the viewing surface. The pattern can be, for example, the text to a book.

One of the biggest advantages to state-of-the art electrophoretic displays is their ability to retain an image after driving energy has been removed. This is known as “bistability” but relates to maintaining a pixel optical state regardless of that optical state. In other words, the terms bistable and bistability historically referred to displays comprising display elements having first and second display states differing in at least one optical property (black/white), and such that after any given element has been driven, by means of an addressing pulse of finite duration, to assume either its first or second display state, after the addressing pulse has terminated, that state will persist for at least several times, for example at least four times, the minimum duration of the addressing pulse required to change the state of the display element. However, with modern electrophoretic displays (EPD) the devices are capable of maintaining gray scale states between extreme black and white states but also colors when using color filter arrays or multi-particle electrophoretic media. This type of display is properly called multi-stable rather than bistable, although for convenience the term bistable may be used herein to cover both bistable and multi-stable displays.

While the bistable nature of electrophoretic displays allows for massive power savings over traditional “always on” displays such as LCD and LED, the bistability can lead to image retention between updates as well as transient colors, a.k.a. “ghosts”. In some instances, prior image information, such as a text box, will be viewable on any newly updated image. In other instances, pixels may show colors that are not correct according to the image file. For example, a page of black and white text may have areas of white that appear yellowish because of prior state updates or a lack of complete colored-pigment separation. In other instances, an area of pixels may shift color because of local differences in temperature or light exposure across a display panel. Such ghosts can be displeasing to a user, and it is beneficial to remove the ghosts, typically with a full screen update. Many commercial devices, such as those manufactured by Onyx BOOX have a button on the screen for just this purpose, allowing a user to remove all of the ghosts at their convenience.

Newer electrophoretic displays offer a variety of color options, including four-color displays (black, white, red, yellow; red, white, yellow, semi-transparent blue; cyan, yellow, magenta, white). Electrophoretic displays with four types of electrophoretic particles operate similar to the simple black and white displays EPDs when, for example, a single color matching the color of one of the particles is desired at the viewing surface. However, obtaining a broader color gamut, including mixed colors and process colors is more complicated and requires more exquisite control of the relative positions of the particles with respect to each other and the viewing surface. When done correctly, such four particle systems allow hundreds of different colors to be produced at each pixel. More details of such systems are available in the following U.S. Patents, all of which are incorporated by reference in their entireties: U.S. Pat. Nos. 9,361,836, 9,921,451, 10,276,109, 10,353,266, 10,467,984, and 10,593,272.

Color electrophoretic displays can also be achieved using color filters arrays (CFA) disposed above or below a layer of electrophoretic display materials, for example a layer of microcapsules with black and white oppositely-charged particles that change position relative to a viewer due to a provided electric field. See, e.g., U.S. Pat. Nos. 8,098,418 and 10,444,592. However, electrophoretic displays incorporating CFAs suffer from loss of color spatial resolution due to subpixels.

For the most part, electrophoretic media, such as described above, are designed to be driven with low voltage square waves, such as produced by a driver circuit from a thin-film-transistor backplane. Such driver circuits can be inexpensively mass-produced because they are very closely related to the driving circuitry and fabrication methods that are used to produce liquid crystal display panels, such as found in smart phones, laptop monitors, and televisions. Historically, even when electrophoretic media are driven directly via an isolated electrode (e.g., segmented electrode) the driving pulses are delivered as square waves, having an amplitude and a time width. See, for example, U.S. Pat. No. 7,012,600, incorporated by reference in its entirety. Typically, for an active matrix backplane including an array of pixel electrodes, each pixel electrode will receive a signal pulse (square wave) for a short period of time as the array of pixel electrodes are addressed in a line-by-line fashion. The period of time that it takes to update the entire array of pixels, and also the time between updates of an individual pixel electrode is known as a frame. The collection of voltage impulses required to change the display from a first display state to a second state is generally known as a waveform. A waveform typically includes at least three frames, e.g., as described in U.S. Pat. No. 11,620,959, which is incorporated by reference in its entirety.

When the electrophoretic medium includes multiple types of particles with the same charge polarity but different charge magnitudes, the final position of a given set of particles (and the optical state) is typically controlled with a sequence of positive and negative voltage impulses. For example, all of the positive particles may be driven to the viewing surface and then a combination of negative and positive voltages serves to disaggregate the collection of positive particles and drive the unwanted positive particles away from the view surface so that only the desired particle sets are viewed. However, driving methods that require multiple positive and negative pulses often result in color transitions that are visibly jarring to a user, also known as “flashy updates.” It is possible to decrease the amount of flash by making the waveforms longer and using smaller voltage steps, however such waveforms are not suitable for applications such as page turning or stylus writing. In such applications, a user expects a nearly instantaneous response by the display and high contrast between first and second optical states. (See, e.g., U.S. Patent Publication No. 2022/0262323 for a description of long gradual waveforms.) Historically, it has been difficult to achieve a short, low flash, low latency color waveform for such multi-particle systems.

Electro-optic displays typically have a backplane provided with a plurality of pixel electrodes each of which defines one pixel of the display. Each pixel electrode is typically disposed in a rectangular array of pixel electrodes and each pixel electrode is controlled with a thin-film transistor (TFT), and the TFT's are updated in a row-by-row fashion. Conventionally, a single common electrode extending over a large number of pixels, and normally the whole display is provided on the opposed side of the electro-optic medium. The individual pixel electrodes may be driven directly (i.e., a separate conductor may be provided to each pixel electrode) or the pixel electrodes may be driven in an active matrix manner which will be familiar to those skilled in backplane technology. Since adjacent pixel electrodes will often be at different voltages, they must be separated by inter-pixel gaps of finite width in order to avoid electrical shorting between electrodes. Although at first glance it might appear that the electro-optic medium overlying these gaps would not switch when drive voltages are applied to the pixel electrodes (and indeed, this is often the case with some non-bistable electro-optic media, such as liquid crystals, where a black mask is typically provided to hide these non-switching gaps), in the case of many bistable electro-optic media the medium overlying the gap does switch because of a phenomenon known as “blooming”.

Blooming refers to the tendency for application of a drive voltage to a pixel electrode to cause a change in the optical state of the electro-optic medium over an area larger than the physical size of the pixel electrode. An area of blooming is not a uniform color, but is typically a transition zone where, as one moves across the area of blooming, the color of the medium transitions from the desired color to another shade or color, for example a desired white pixel may include various shades of gray along the edges, a.k.a., “edge ghosting”. Furthermore depending upon the type of display, i.e., black/white, color, black/white with color filter, the results of the edge ghosting can range from annoying to debilitating. In some cases, asymmetric blooming may contribute to edge ghosting. Edge ghosting can also be removed with the methods described herein.

Much of the discussion below will focus on methods for driving one or more pixel electrodes of an electro-optic display through a transition from a first optical (i.e., color) state to a final optical state (which may or may not be different from the initial optical state). The term “waveform” will be used to denote the entire voltage against time curve used to effect the transition from one specific first color state to a specific second color state. Typically, such a waveform will comprise a plurality of waveform elements; where these elements are essentially rectangular (V×t) voltage pulses (i.e., where a given element comprises application of a constant voltage for a period of time); the elements may be called “pulses” or “drive pulses”. The term “drive scheme” denotes a set of waveforms sufficient to effect all possible transitions between gray levels for a specific display. A display may make use of more than one drive scheme; for example, the aforementioned U.S. Pat. No. 7,012,600 teaches that a drive scheme may need to be modified depending upon parameters such as the temperature of the display or the time for which it has been in operation during its lifetime, and thus a display may be provided with a plurality of different drive schemes to be used at differing temperature etc. A set of drive schemes used in this manner may be referred to as “a set of related drive schemes.” It is also possible, as described in several of the aforementioned MEDEOD applications, to use more than one drive scheme simultaneously in different areas of the same display, and a set of drive schemes used in this manner may be referred to as “a set of simultaneous drive schemes.”

The term impulse, when used to refer to driving an electrophoretic display, is used herein to refer to the integral of the applied voltage with respect to time during the period in which the display is driven. The term waveform, when used to refer to driving an electrophoretic display is used to describe a series or pattern of voltages provided to an electrophoretic medium over a given time period (seconds, frames, etc.) to produce a desired optical effect in the electrophoretic medium.

A particle that absorbs, scatters, or reflects light, either in a broad band or at selected wavelengths, is referred to herein as a colored or pigment particle. Various materials other than pigments (in the strict sense of that term as meaning insoluble colored materials) that absorb or reflect light, such as dyes or photonic crystals, etc., may also be used in the electrophoretic media and displays of the present invention.

Numerous patents and applications assigned to or in the names of the Massachusetts Institute of Technology (MIT) and E Ink Corporation describe various technologies used in encapsulated electrophoretic and other electro-optic media. Such encapsulated media comprise numerous small capsules, each of which itself comprises an internal phase containing electrophoretically-mobile particles in a fluid medium, and a capsule wall surrounding the internal phase. Typically, the capsules are themselves held within a polymeric binder to form a coherent layer positioned between two electrodes. The technologies described in these patents and applications include:
(a) Electrophoretic particles, fluids and fluid additives; see for example U.S. Pat. Nos. 7,002,728 and 7,679,814;
(b) Capsules, binders and encapsulation processes; see for example U.S. Pat. Nos. 6,922,276 and 7,411,719;
(c) Microcell structures, wall materials, and methods of forming microcells; see for example U.S. Pat. Nos. 7,072,095 and 9,279,906;
(d) Methods for filling and sealing microcells; see for example U.S. Pat. Nos. 7,144,942 and 7,715,088;
(e) Films and sub-assemblies containing electro-optic materials; see for example U.S. Pat. Nos. 6,982,178 and 7,839,564;
(f) Backplanes, adhesive layers and other auxiliary layers and methods used in displays; see for example U.S. Pat. Nos. 7,116,318 and 7,535,624;
(g) Color formation color adjustment; see for example U.S. Pat. Nos. 6,017,584; 6,545,797; 6,664,944; 6,788,452; 6,864,875; 6,914,714; 6,972,893; 7,038,656; 7,038,670; 7,046,228; 7,052,571; 7,075,502; 7,167,155; 7,385,751; 7,492,505; 7,667,684; 7,684,108; 7,791,789; 7,800,813; 7,821,702; 7,839,564; 7,910,175; 7,952,790; 7,956,841; 7,982,941; 8,040,594; 8,054,526; 8,098,418; 8,159,636; 8,213,076; 8,363,299; 8,422,116; 8,441,714; 8,441,716; 8,466,852; 8,503,063; 8,576,470; 8,576,475; 8,593,721; 8,605,354; 8,649,084; 8,670,174; 8,704,756; 8,717,664; 8,786,935; 8,797,634; 8,810,899; 8,830,559; 8,873,129; 8,902,153; 8,902,491; 8,917,439; 8,964,282; 9,013,783; 9,116,412; 9,146,439; 9,164,207; 9,170,467; 9,170,468; 9,182,646; 9,195,111; 9,199,441; 9,268,191; 9,285,649; 9,293,511; 9,341,916; 9,360,733; 9,361,836; 9,383,623; and 9,423,666; and U.S. Patent Applications Publication Nos. 2008/0043318; 2008/0048970; 2009/0225398; 2010/0156780; 2011/0043543; 2012/0326957; 2013/0242378; 2013/0278995; 2014/0055840; 2014/0078576; 2014/0340430; 2014/0340736; 2014/0362213; 2015/0103394; 2015/0118390; 2015/0124345; 2015/0198858; 2015/0234250; 2015/0268531; 2015/0301246; 2016/0011484; 2016/0026062; 2016/0048054; 2016/0116816; 2016/0116818; and 2016/0140909;
(h) Methods for driving displays; see for example U.S. Pat. Nos. 5,930,026; 6,445,489; 6,504,524; 6,512,354; 6,531,997; 6,753,999; 6,825,970; 6,900,851; 6,995,550; 7,012,600; 7,023,420; 7,034,783; 7,061,166; 7,061,662; 7,116,466; 7,119,772; 7,177,066; 7,193,625; 7,202,847; 7,242,514; 7,259,744; 7,304,787; 7,312,794; 7,327,511; 7,408,699; 7,453,445; 7,492,339; 7,528,822; 7,545,358; 7,583,251; 7,602,374; 7,612,760; 7,679,599; 7,679,813; 7,683,606; 7,688,297; 7,729,039; 7,733,311; 7,733,335; 7,787,169; 7,859,742; 7,952,557; 7,956,841; 7,982,479; 7,999,787; 8,077,141; 8,125,501; 8,139,050; 8,174,490; 8,243,013; 8,274,472; 8,289,250; 8,300,006; 8,305,341; 8,314,784; 8,373,649; 8,384,658; 8,456,414; 8,462,102; 8,514,168; 8,537,105; 8,558,783; 8,558,785; 8,558,786; 8,558,855; 8,576,164; 8,576,259; 8,593,396; 8,605,032; 8,643,595; 8,665,206; 8,681,191; 8,730,153; 8,810,525; 8,928,562; 8,928,641; 8,976,444; 9,013,394; 9,019,197; 9,019,198; 9,019,318; 9,082,352; 9,171,508; 9,218,773; 9,224,338; 9,224,342; 9,224,344; 9,230,492; 9,251,736; 9,262,973; 9,269,311; 9,299,294; 9,373,289; 9,390,066; 9,390,661; and 9,412,314; and U.S. Patent Applications Publication Nos. 2003/0102858; 2004/0246562; 2005/0253777; 2007/0091418; 2007/0103427; 2007/0176912; 2008/0024429; 2008/0024482; 2008/0136774; 2008/0291129; 2008/0303780; 2009/0174651; 2009/0195568; 2009/0322721; 2010/0194733; 2010/0194789; 2010/0220121; 2010/0265561; 2010/0283804; 2011/0063314; 2011/0175875; 2011/0193840; 2011/0193841; 2011/0199671; 2011/0221740; 2012/0001957; 2012/0098740; 2013/0063333; 2013/0194250; 2013/0249782; 2013/0321278; 2014/0009817; 2014/0085355; 2014/0204012; 2014/0218277; 2014/0240210; 2014/0240373; 2014/0253425; 2014/0292830; 2014/0293398; 2014/0333685; 2014/0340734; 2015/0070744; 2015/0097877; 2015/0109283; 2015/0213749; 2015/0213765; 2015/0221257; 2015/0262255; 2015/0262551; 2016/0071465; 2016/0078820; 2016/0093253; 2016/0140910; and 2016/0180777;
(i) Applications of displays; see for example U.S. Pat. Nos. 7,312,784 and 8,009,348; and
(j) Non-electrophoretic displays, as described in U.S. Pat. Nos. 6,241,921; and U.S. Patent Applications Publication Nos. 2015/0277160; and U.S. Patent Application Publications Nos. 2015/0005720 and 2016/0012710.

Many of the aforementioned patents and applications recognize that the walls surrounding the discrete microcapsules in an encapsulated electrophoretic medium could be replaced by a continuous phase, thus producing a so-called polymer-dispersed electrophoretic display, in which the electrophoretic medium comprises a plurality of discrete droplets of an electrophoretic fluid and a continuous phase of a polymeric material, and that the discrete droplets of electrophoretic fluid within such a polymer-dispersed electrophoretic display may be regarded as capsules or microcapsules even though no discrete capsule membrane is associated with each individual droplet; see for example, U.S. Pat. No. 6,866,760. Accordingly, for purposes of the present application, such polymer-dispersed electrophoretic media are regarded as sub-species of encapsulated electrophoretic media.

A related type of electrophoretic display is a so-called microcell electrophoretic display. In a microcell electrophoretic display, the charged particles and the fluid are not encapsulated within microcapsules but instead are retained within a plurality of cavities formed within a carrier medium, typically a polymeric film. See, for example, U.S. Pat. Nos. 6,672,921 and 6,788,449.

Although electrophoretic media are often opaque (since, for example, in many electrophoretic media, the particles substantially block transmission of visible light through the display) and operate in a reflective mode, many electrophoretic displays can be made to operate in a so-called shutter mode in which one display state is substantially opaque and one is light-transmissive. See, for example, U.S. Pat. Nos. 5,872,552; 6,130,774; 6,144,361; 6,172,798; 6,271,823; 6,225,971; and 6,184,856. Dielectrophoretic displays, which are similar to electrophoretic displays but rely upon variations in electric field strength, can operate in a similar mode; see U.S. Pat. No. 4,418,346. Other types of electro-optic displays may also be capable of operating in shutter mode. Electro-optic media operating in shutter mode can be used in multi-layer structures for full color displays; in such structures, at least one layer adjacent the viewing surface of the display operates in shutter mode to expose or conceal a second layer more distant from the viewing surface.

An encapsulated electrophoretic display typically does not suffer from the clustering and settling failure mode of traditional electrophoretic devices and provides further advantages, such as the ability to print or coat the display on a wide variety of flexible and rigid substrates. (Use of the word printing is intended to include all forms of printing and coating, including, but without limitation: pre-metered coatings such as patch die coating, slot or extrusion coating, slide or cascade coating, curtain coating; roll coating such as knife over roll coating, forward and reverse roll coating; gravure coating; dip coating; spray coating; meniscus coating; spin coating; brush coating; air knife coating; silk screen printing processes; electrostatic printing processes; thermal printing processes; ink jet printing processes; electrophoretic deposition (See U.S. Pat. No. 7,339,715); and other similar techniques.) Thus, the resulting display can be flexible. Further, because the display medium can be printed (using a variety of methods), the display itself can be made inexpensively. Additionally, as described in US Patent Application Publication No. 2021/0132459, encapsulated electrophoretic media can be incorporated into non-planar surfaces that are, in turn, incorporated into everyday objects. As a result, surfaces of products, building materials, etc. can be engineered to change color when a suitable electric field is supplied.

### SUMMARY

In one aspect, the invention includes a method for reducing color drift in an electrophoretic display undergoing a partial update, wherein the electrophoretic display includes an active matrix of pixel electrodes. The method includes identifying an M×N matrix of pixels that were not updated in a first partial update and remain in a first optical state between the time of the first partial update and a later time that is at least 3 seconds after the first partial update, next sending an update waveform for the first optical state to each pixel of the M×N matrix of pixels in order to reduce color drift in the electrophoretic display, and next sending no waveform to pixels that were not updated in the first partial update and remain in the first optical state between the time of the first partial update and the later time that is at least 3 seconds after the first partial update but were not included in the identified M×N matrix of pixels. In some embodiments, the update waveform for the first optical state is shorter in length than a standard waveform for a transition from a neutral state to the first optical state. In some embodiments, the first optical state is a white optical state. In some embodiments, the M×N matrix of pixels includes at least 9 pixels. In some embodiments, the method further comprises (after sending an update waveform to each pixel of the M×N matrix of pixels) identifying a different M′×N′ matrix of pixels that were not updated in the first partial update and remain in the first optical state between the time of the first partial update and a later time that is at least 3 seconds after the first partial update and sending an update waveform for the first optical state to each pixel of the M′×N′ matrix of pixels. In some embodiments, the M×N matrix of pixels is larger than the M′×N′ matrix of pixels. In some embodiments, the method further comprises (after sending an update waveform to each pixel of the M×N matrix of pixels) identifying a different M′×N′ matrix of pixels that were not updated in the first partial update and which remain in a second optical state between the time of the first partial update and a later time that is at least 3 seconds after the first partial update and sending an update waveform for the second optical state to each pixel of the M′×N′ matrix of pixels. In some embodiments, the M×N matrix of pixels is the same size as the M′×N′ matrix of pixels. In some embodiments, at least a portion of the electrophoretic display shows a dithered image before the first partial update. In some embodiments, at least a portion of the electrophoretic display shows a dithered image before the first partial update, and the dithered image includes pixels of the first optical state and the second optical state. In some embodiments, the first optical state is a white optical state and the second optical state is a nonwhite optical state, e.g., a black optical state. In some embodiments, the electrophoretic display comprises an electrophoretic medium including electrically charged particles dispersed in a fluid and confined within a plurality of capsules or microcells. In some embodiments, the electrophoretic medium includes four different types of electrically charged particles, and at least two of the types of electrically charged particles have opposite polarities. In some embodiments, the electrophoretic medium includes two positive electrically charged particles and two negative electrically charged particles or three positive electrically charged particles and one negative electrically charged particle or one positive electrically charged particle and three negative electrically charged particles.

### BRIEF DESCRIPTION OF DRAWINGS

FIG. 1A is a representative cross-section of a four-particle electrophoretic display wherein the electrophoretic medium is encapsulated in microcapsules.

FIG. 1B is a representative cross-section of a four-particle electrophoretic display wherein the electrophoretic medium is encapsulated in microcells.

FIG. 1C is a representative cross-section of an electrophoretic display, e.g., including an electrophoretic layer of oppositely charged black and white particles, coupled to a color filter array (CFA) disposed between the electrophoretic layer and the viewer.

FIG. 2A illustrates an exemplary equivalent circuit of a single pixel of an electrophoretic display that uses an active-matrix backplane with a storage capacitor.

FIG. 2B illustrates an exemplary equivalent circuit of a simplified electrophoretic display of the invention, allowing driving in a row-column format.

FIG. 3 illustrates an exemplary electrophoretic display that includes a display module. The electrophoretic display also includes a processor, memory, one or more power supplies, and a controller. The electrophoretic display may also include sensors to allow the electrophoretic display to adjust operational parameters based upon the ambient environment, e.g., temperature and illumination.

FIG. 4A illustrates the preferred position of each of the four sets of particles to produce eight standard colors in a white-cyan-magenta-yellow (WCMY) four-particle electrophoretic display, wherein the white particles are reflective and the cyan, magenta, and yellow particles are absorptive.

FIG. 4B shows exemplary “standard” push-pull drive schemes for addressing an electrophoretic medium of FIG. 4A, i.e., including three subtractive (cyan, yellow, magenta) particles and a scattering (white) particle.

FIG. 4C illustrates the preferred position of each of the four sets of particles to produce seven standard colors in a white-red-yellow-blue semi-absorptive (WRYB*) four-particle electrophoretic display, wherein the white, red, and yellow particles are reflective and the blue particle is semi-absorptive (B*).

FIG. 4D shows exemplary “standard” waveforms for addressing an electrophoretic medium of FIG. 4C, i.e., including three reflective (white, red, yellow) particles and a selectively absorptive (blue) particle. See also U.S. patent application Ser. No. 19/096,885, filed Apr. 1, 2025, which is incorporated by reference in its entirety.

FIG. 5 illustrates different areas of a display having nominally the same color state but experiencing different actual color states (drifts or transients or ghosts).

FIG. 6 illustrates the results of a simple method to remove color drift in the display of FIG. 5. For example, applying the P update to pixels that are outside of the area update, but have not been updated in >=10 s.

FIG. 7 illustrates another embodiment whereby partial updating will cause color state drift between different areas of the display panel.

FIG. 8 illustrates using P transitions during partial updates to reduce the level of ghosting.

FIG. 9 illustrates a method of the invention in which only M×N groups of pixels having the same optical state receive P transitions to maintain a pre-existing dither pattern. The optical states need not be white, however different P transitions are needed for the different (non-white) final optical states.

FIG. 10 shows the benefits of using a P transition during a “white to white” update versus simply making no update to the pixel.

FIG. 11 illustrates exemplary white and black P transition waveforms.

### DETAILED DESCRIPTION

The disclosure details the use of “stomp” waveforms to reduce white state ghosting due to color drift or other transient color shift. While the disclosure primarily focuses on white states, especially in a white, cyan, yellow, magenta four-particle electrophoretic media, related techniques can be used to address color state drift in other multi-particle color platforms, as well as in color-filter-array (CFA) electrophoretic displays.

In many instances, the color drift is related to using partial update methods, whereby only a portion of the display panel receives update instructions from the controller between a first and a second image. Partial update methods save energy because fewer pixel electrodes need to be switched between a first and a second image. Additionally, because fewer pixels are being updated, the transition is perceived to be less “flashy”, i.e., the transition is not jarring to a viewer. However, where only some portion of the display has been updated, the recently updated portion may appear to have a slightly different color because of transient temperature or lighting influence. Additionally, because of inter-pixel coupling, i.e., as discussed in the Background (a.k.a. “blooming”), the borders between updated pixel electrodes and non-updated pixel electrodes during the partial update may experience unintended color state drift, which can result in the shade of a given subpixel being incorrect, the color of a given image pixel being incorrect, or the color of a dithered area of the image being incorrect. Ghosting can be especially pronounced when one area of the display is repeatedly driven, while the rest remains without updates, i.e., a video-rate countdown clock. Using the methods of the invention, many of the color and ghosting problems can be minimized in color electrophoretic displays, regardless of the nature of the color electrophoretic display, be it multiple different-colored particles at each pixel electrode or a color filter array display including black and white particles beneath each subpixel of the display pixel.

Methods for fabricating an electrophoretic display including two, three, four (or more) particles have been discussed in the prior art. The electrophoretic fluid may be encapsulated in microcapsules or incorporated into microcell structures that are thereafter sealed with a polymeric layer. The microcapsule or microcell layers may be coated or laminated to a plastic substrate or film bearing a transparent coating of an electrically conductive material. Alternatively, the microcapsules may be coated onto a light transmissive substrate or other electrode material using spraying techniques. (See U.S. Pat. No. 9,835,925, incorporated by reference herein). The resulting assembly may be laminated to a backplane including pixel electrodes using an electrically conductive adhesive. The assembly may alternatively be attached to one or more segmented electrodes on a backplane, wherein the segmented electrodes are driven directly. In another embodiment the assembly, which may include a non-planar light transmissive electrode material is spray coated with capsules and then overcoated with a back electrode material. (See U.S. Patent Publication No. 2021/0132459, incorporated by reference herein.) Alternatively, the electrophoretic fluid may be dispensed directly on a thin open-cell grid that has been arranged on a backplane including an active matrix of pixel electrodes. The filled grid can then be top-sealed with an integrated protective sheet/light-transmissive electrode.

An electrophoretic display normally comprises a layer of electrophoretic material and at least two other layers disposed on opposed sides of the electrophoretic material, one of these two layers being an electrode layer. In most such displays both the layers are electrode layers, and one or both of the electrode layers are patterned to define the pixels of the display. For example, one electrode layer may be patterned into elongate row electrodes and the other into elongate column electrodes running at right angles to the row electrodes, the pixels being defined by the intersections of the row and column electrodes. Alternatively, and more commonly, one electrode layer has the form of a single continuous electrode and the other electrode layer is patterned into a matrix of pixel electrodes, each of which defines one pixel of the display. In another type of electrophoretic display, which is intended for use with a stylus, print head or similar movable electrode separate from the display, only one of the layers adjacent the electrophoretic layer comprises an electrode, the layer on the opposed side of the electrophoretic layer typically being a protective layer intended to prevent the movable electrode damaging the electrophoretic layer.

Electrophoretic media used herein include charged particles that vary in color, reflective or absorptive properties, charge density, and mobility in an electric field (measured as a zeta potential). A particle that absorbs, scatters, or reflects light, either in a broad band or at selected wavelengths, is referred to herein as a colored or pigment particle. Various materials other than pigments (in the strict sense of that term as meaning insoluble colored materials) that absorb or reflect light, such as dyes or photonic crystals, etc., may also be used in the electrophoretic media and displays of the present invention. For example, the electrophoretic medium might include a fluid, a plurality of first and a plurality of second particles dispersed in the fluid, the first and second particles bearing charges of opposite polarity, the first particle being a light-scattering particle and the second particle having one of the subtractive primary colors, and a plurality of third and a plurality of fourth particles dispersed in the fluid, the third and fourth particles bearing charges of opposite polarity, the third and fourth particles each having a subtractive primary color different from each other and from the second particles, wherein the electric field required to separate an aggregate formed by the third and the fourth particles is greater than that required to separate an aggregate formed from any other two types of particles.

The electrophoretic media of the present invention may contain any of the additives used in prior art electrophoretic media as described for example in the E Ink and MIT patents and applications mentioned above. Thus, for example, the electrophoretic medium of the present invention will typically comprise at least one charge control agent to control the charge on the various particles, and the fluid may have dissolved or dispersed therein a polymer having a number average molecular weight in excess of about 20,000 and being essentially non-absorbing on the particles to improves the bistability of the display, as described in the aforementioned U.S. Pat. No. 7,170,670.

In one embodiment, the present invention uses a light-scattering particle, typically white, and three substantially non-light-scattering particles. There is of course no such thing as a completely light-scattering particle or a completely non-light-scattering particle, and the minimum degree of light scattering of the light-scattering particle, and the maximum tolerable degree of light scattering tolerable in the substantially non-light-scattering particles, used in the electrophoretic of the present invention may vary somewhat depending upon factors such as the exact pigments used, their colors and the ability of the user or application to tolerate some deviation from ideal desired colors. The scattering and absorption characteristics of a pigment may be assessed by measurement of the diffuse reflectance of a sample of the pigment dispersed in an appropriate matrix or liquid against white and dark backgrounds. Results from such measurements can be interpreted according to a number of models that are well-known in the art, for example, the one-dimensional Kubelka-Munk treatment. In the present invention, it is preferred that the white pigment exhibit a diffuse reflectance at 550 nm, measured over a black background, of at least 5% when the pigment is approximately isotropically distributed at 15% by volume in a layer of thickness 1 μm comprising the pigment and a liquid of refractive index less than 1.55. The yellow, magenta and cyan pigments preferably exhibit diffuse reflectances at 650, 650 and 450 nm, respectively, measured over a black background, of less than 2.5% under the same conditions. (The wavelengths chosen above for measurement of the yellow, magenta and cyan pigments correspond to spectral regions of minimal absorption by these pigments.) Colored pigments meeting these criteria are hereinafter referred to as “non-scattering” or “substantially non-light-scattering”. Specific examples of suitable particles are disclosed in U.S. Pat. Nos. 9,921,451, which is incorporated by reference herein.

Alternative particle sets may also be used, including four sets of reflective particles, or one absorptive particle with three or four sets of different reflective particles, i.e., such as described in U.S. Pat. Nos. 9,922,603 and 10,032,419, which are incorporated by reference herein. For example, white particles may be formed from an inorganic pigment, such as TiO₂, ZrO₂, ZnO, Al₂O₃, Sb₂₀₃, BaSO₄, PbSO₄ or the like, while black particles may be formed from CI pigment black 26 or 28 or the like (e.g., manganese ferrite black spinel or copper chromite black spinel) or carbon black. The third/fourth/fifth type of particles may be of a color such as red, green, blue, magenta, cyan or yellow. The pigments for this type of particles may include, but are not limited to, CI pigment PR 254, PR122, PR149, PG36, PG58, PG7, PB28, PB15:3, PY138, PY150, PY155 or PY20. Specific examples include Clariant Hostaperm Red D3G 70-EDS, Hostaperm Pink E-EDS, PV fast red D3G, Hostaperm red D3G 70, Hostaperm Blue B2G-EDS, Hostaperm Yellow H4G-EDS, Hostaperm Green GNX, BASF Irgazine red L 3630, Cinquasia Red L 4100 HD, and Irgazin Red L 3660 HD; Sun Chemical phthalocyanine blue, phthalocyanine green, diarylide yellow or diarylide AAOT yellow.

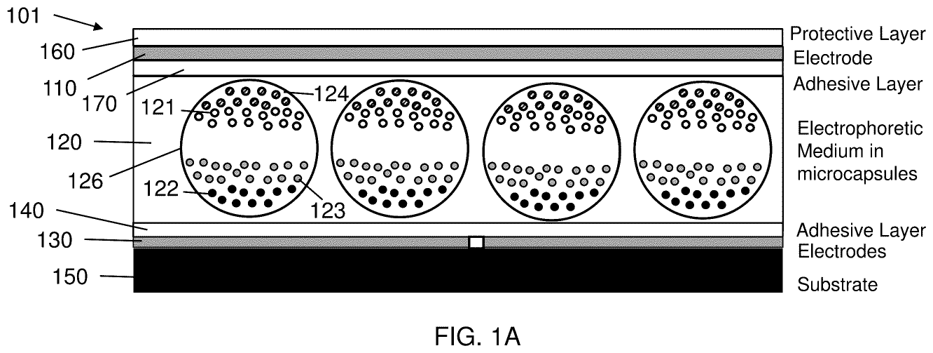

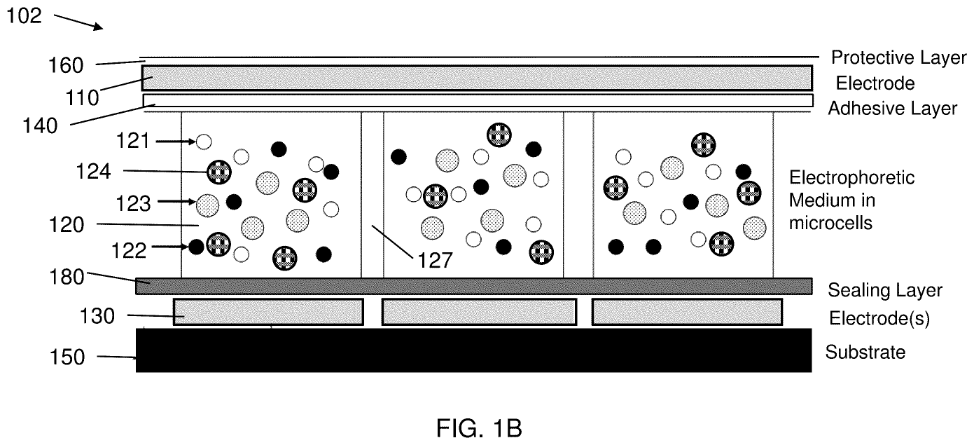

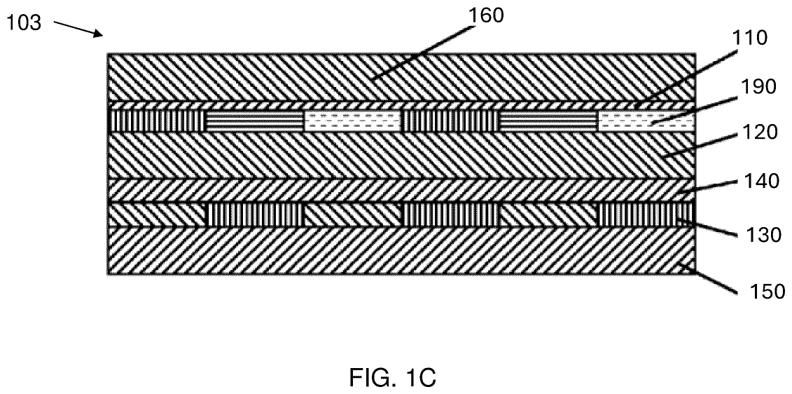

As shown in FIGS. 1A, 1B, and 1C, an electrophoretic display (101, 102, 103) typically includes a top transparent electrode 110, an electrophoretic medium 120, and a bottom electrode 130, which is often a pixel electrode of an active matrix of pixels controlled with thin film transistors (TFT). However, the bottom electrode 130 can be a singular larger electrode, such as a graphite backplane, a film of PET/ITO, a metalized film, or a conductive paint. In the electrophoretic media 120 described in FIGS. 1A and 1B, there are four different types of particles, 121, 122, 123, and 124, however more particle sets can be used with the methods and displays described herein. In the CFA display 103, the electrophoretic medium 120 may include an encapsulated electrophoretic medium with only black and white oppositely-charged particles. Such CFA films are available from Toppan Printing (Japan). Alternatively, the color filter elements may be applied to the electrophoretic media 120 with an ink-jet or other precision printing process. See U.S. Pat. No. 10,209,556.

In FIGS. 1A and 1B and similar embodiments, two of the four different types of particle sets, 121, 122, 123, and 124 are of first polarity, while the other two sets are of a second (opposite) polarity. In some embodiments, one of the four different types of particle sets, 121, 122, 123, and 124 is of first polarity, while the other three sets are of a second (opposite) polarity. In some embodiments two of the four different types of particle sets are of a first polarity, while the other two sets are of an opposite polarity. The electrophoretic medium 120 is typically compartmentalized by a microcapsule 126 or the walls of a microcell 127. An optional adhesive layer 140 can be disposed adjacent any of the layers, however, it is typically adjacent an electrode layer (110 or 130). There may be more than one adhesive layer 140 in a given electrophoretic display (105, 106), however only one layer is more common. The entire display stack is typically disposed on a substrate 150, which may be rigid or flexible. The display (101, 102) typically also includes a protective layer 160, which may simply protect the top electrode 110 from damage, or it may envelop the entire display (101, 102) to prevent ingress of water, etc. Electrophoretic displays (101, 102) may also include sealing layers 180 as needed. In some embodiments the adhesive layer 140 may include a primer component to improve adhesion to the electrode layer 110, or a separate primer layer (not shown in FIG. 1B) may be used. The structures of electrophoretic displays and the component parts, pigments, adhesives, electrode materials, etc., are described in many patents and patent applications published by E Ink Corporation, such as U.S. Pat. Nos. 6,922,276; 7,002,728; 7,072,095; 7,116,318; 7,715,088; and 7,839,564, all of which are incorporated by reference herein in their entireties.

In some embodiments, e.g., as shown in FIG. 1A, the electrophoretic display may include only a first light-transmissive electrode, an electrophoretic medium, and a second (rear) electrode, which may also be light-transmissive. However, to produce a high-resolution display, e.g. e.g., as shown in FIG. 1B. Of course, each pixel must be addressable without interference from adjacent pixels so that an image file is faithfully reproduced in the display. One way to achieve this objective is to provide an array of non-linear elements, such as transistors or diodes, with at least one non-linear element associated with each pixel, to produce an “active matrix” display. An addressing or pixel electrode, which addresses one pixel, is connected to an appropriate voltage source through the associated non-linear element. Typically, when the non-linear element is a transistor, the pixel electrode is connected to the drain of the transistor, and this arrangement will be assumed in the following description, although it is essentially arbitrary and the pixel electrode could be connected to the source of the transistor. Conventionally, in high resolution arrays, the pixels are arranged in a two-dimensional array of rows and columns, such that any specific pixel is uniquely defined by the intersection of one specified row and one specified column. The sources of all the transistors in each column are connected to a single column electrode, while the gates of all the transistors in each row are connected to a single row electrode. The assignment of sources to rows and gates to columns is conventional but essentially arbitrary and could be reversed if desired. The row electrodes are connected to a row driver, which essentially ensures that at any given moment only one row is selected, i.e., that there is applied to the selected row electrode a select voltage such as to ensure that all the transistors in the selected row are conductive, while there is applied to all other rows a non-select voltage such as to ensure that all the transistors in these non-selected rows remain non-conductive. The column electrodes are connected to column drivers, which place upon the various column electrodes voltages selected to drive the pixels in the selected row to their desired optical states. (The aforementioned voltages are relative to a common front electrode which is conventionally provided on the opposed side of the electro-optic medium from the non-linear array and extends across the whole display.)

After a pre-selected interval known as the “line address time” the selected row is deselected, the next row is selected, and the voltages on the column drivers are changed so that the next line of the display is written. This process is repeated so that the entire display is written in a row-by-row manner. The entire process is coordinated with a clock circuit. The time between addressing a pixel for the nth time and the following addressing, n+1, is known as a “frame.” Thus, a display that is updated at 60 Hz has frames that are 16 msec. “Frames” are not limited to use with an active matrix backplane, however. The driving frames described herein can also be used to refer to a unit of time between updates of, e.g., a singular backplane. While it is possible to drive electrophoretic media with an analog voltage signal, such as produced by a power supply and a potentiometer, the use of a digital controller discretizes the waveform into blocks that are typically on the order of 10 ms, however shorter or longer framewidths are possible. For example, a frame can be 0.5 ms, or greater, such as 1 ms, 5 ms, 10 ms, 15 ms, 20 ms, 30 ms, or 50 ms. In most instances a frame is less than 100 ms, such 250 ms, 200 ms, 150 ms, or 100 ms. In most applications described herein, the frame is between 5 ms and 30 ms in width, for example 8 ms in width. Specialized drive controllers for electrophoretic displays are available from, e.g., Ultrachip and Rockchip, however programmable voltage drivers can also be used, such as available from Digi-Key and other electronics components suppliers.

In a conventional electrophoretic display using an active-matrix backplane, each pixel electrode has associated therewith a capacitor electrode (storage capacitor) such that the pixel electrode and the capacitor electrode form a capacitor; see, for example, International Patent Publication WO 01/07961. In some embodiments, N-type semiconductor (e.g., amorphous silicon) may be used to form the transistors and the “select” and “non-select” voltages applied to the gate electrodes can be positive and negative, respectively.

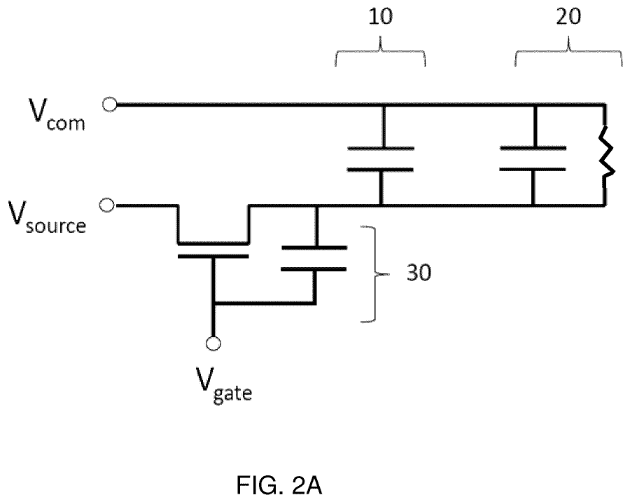

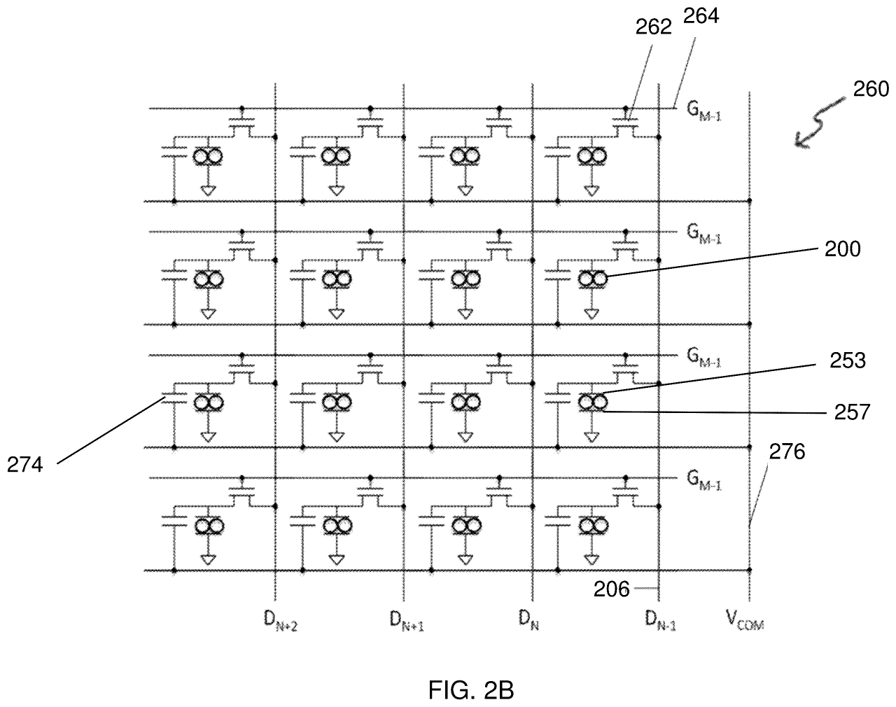

FIG. 2A of the accompanying drawings depicts an exemplary equivalent circuit of a single pixel of an electrophoretic display. As illustrated, the circuit includes a capacitor 10 formed between a pixel electrode and a capacitor electrode. The electrophoretic medium 20 is represented as a capacitor and a resistor in parallel. In some instances, direct or indirect coupling capacitance 30 between the gate electrode of the transistor associated with the pixel and the pixel electrode (usually referred to a as a “parasitic capacitance”) may create unwanted noise to the display. Usually, the parasitic capacitance 30 is much smaller than that of the storage capacitor 10, and when the pixel rows of a display is being selected or deselected, the parasitic capacitance 30 may result in a small negative offset voltage to the pixel electrode, also known as a “kickback voltage”, which is usually less than 2 volts. [In some embodiments, to compensate for the unwanted “kickback voltage”, a common potential V_{com}, may be supplied to the top plane electrode and the capacitor electrode associated with each pixel, such that, when V_{com} is set to a value equal to the kickback voltage (V_{KB}), every voltage supplied to the display may be offset by the same amount, and no net DC-imbalance experienced.]

In many embodiments, the TFT array forms an active matrix 260 for image driving, as shown in FIG. 2B. For example, each pixel electrode 253 (corresponding to 130 in FIGS. 1A and 1B) is coupled to a thin-film transistor 262 patterned into an array and connected to gate (row) driver lines 264 and source (column) driver lines 206, running at right angles to the gate drive lines 264. Also, typically, the common (top) light-transparent electrode 257 (corresponding to 110 in FIGS. 1A and 1B) has the form of a single continuous electrode while the other electrode or electrode layer is patterned into a matrix of pixel electrodes 253, each of which defines one pixel of the display. Between the pixel electrode 253 and the common electrode 257, an electrophoretic medium 200 can be disposed. Any of the electrophoretic media described above may be used, and while FIG. 2B depicts the electrophoretic medium as contained in microcapsules, microcells, as shown in FIG. 1B, as also suitable. A source driver (not shown) is connected to the source driver lines 206 and provides source voltage to all TFTs 262 in a column that are to be addressed. A gate driver (not shown) is connected to the gate driver lines 264 to provide a bias voltage that will open (or close) the gates of each TFT 262 along the row. The gate scanning rate is typically ˜60-150 Hz. When the TFTs 262 are n-type, taking the gate-source voltage positive allows the source voltage to be shorted to the drain. Taking the gate negative with respect to the source causes the drain source current to drop and the drain effectively floats. Because the scan driver acts in a sequential fashion, there is typically some measurable delay in update time between the top and bottom row electrodes. It is understood that the assignment of “row” and “column” electrodes is somewhat arbitrary and that a TFT array could be fabricated with the roles of the row and column electrodes interchanged. Each pixel of the active matrix 260 also includes a storage capacitor 274 as discussed above with respect to FIG. 2A. The storage capacitors 274 are typically coupled to V_{com} line 276. In some embodiments the common light-transparent electrode 257 is coupled to ground, as shown in FIG. 2B. In other embodiments, the common light-transparent electrode 257 is also coupled to V_{com} line 276 (not shown in FIG. 2B).

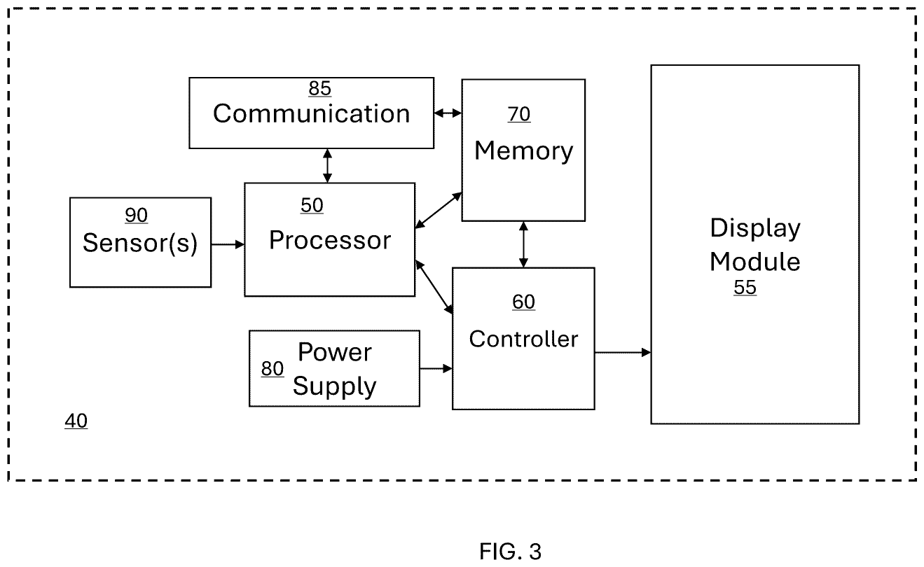

The active matrix 260 described with respect to FIG. 2B (i.e., including the electrophoretic medium 200 and the common light-transparent electrode 257) is typically covered by a protective sheet (e.g., integrated barrier) and sealed to create a display module 55, as shown in FIG. 3. Such a display module 55 becomes the focus of an electrophoretic display 40. The electrophoretic display 40 will typically include a processor 50, which is configured to coordinate the many functions relating to displaying content on the display module 55, and to transform “standard” images, such as sRGB images to a color regime that best duplicates the image on the display module 55. In some embodiments, the processor 50 performs the methods of the invention by determining which pixel electrodes should be updated during a partial update. Especially when dithering is being used for color production, the processor 50 can determine which areas of the dithered color are most at risk from blooming due to nearby pixel electrode updates. In other embodiments, some or all of the steps of the invention may be completed by the controller 60. As controller 60 architecture advances, more of the image processing can be embedded into the controller 60 such that an advanced controller can be incorporated into the same package as the display module 55 and pre-programmed with the tools needed to identify pixel electrodes that are at risk of blooming during a partial update. Advanced controllers for electrophoretic displays are available from ULTRACHIP and NEXTRONIX.

The processor 50 is typically a mobile processor chip, such as made by Freescale or Qualcomm, although other manufacturers are known. The processor 50 is in frequent communication with the non-transitory memory 70, from which it pulls image files and/or look up tables to perform the color image transformations described below. The non-transitory memory 70 may also include gate driving instructions to the extent that a particular color transition may require a different gate driving pattern. The electrophoretic display 40 may have more than one non-transitory memory chip. The non-transitory memory 70 may be flash memory. Once the desired image has been converted for display on the display module 55, the specific image instructions are sent to a controller 60, which facilitates voltage sequences being sent to the respective thin film transistors (described above). Such voltages typically originate from one or more power supplies 80, which may include, e.g., a power management integrated chip (PMIC). The electrophoretic display 40 may additionally include communication 85, which may be, for example, WIFI protocols or BLUETOOTH, and allows the electrophoretic display 40 to receive images and instructions, which also may be stored in memory 70. The electrophoretic display 40 may additionally include one or more sensors 90, which may include a temperature sensor and/or a photo sensor, and such information can be fed to the processor 50 to allow the processor to select an optimum look-up-table when such look-up-tables are indexed for ambient temperature or incident illumination intensity or spectrum. In some instances, multiple components of the electrophoretic display 40 can be embedded in a singular integrated circuit. For example, a specialized integrated circuit may fulfill the functions of processor 50 and controller 60.

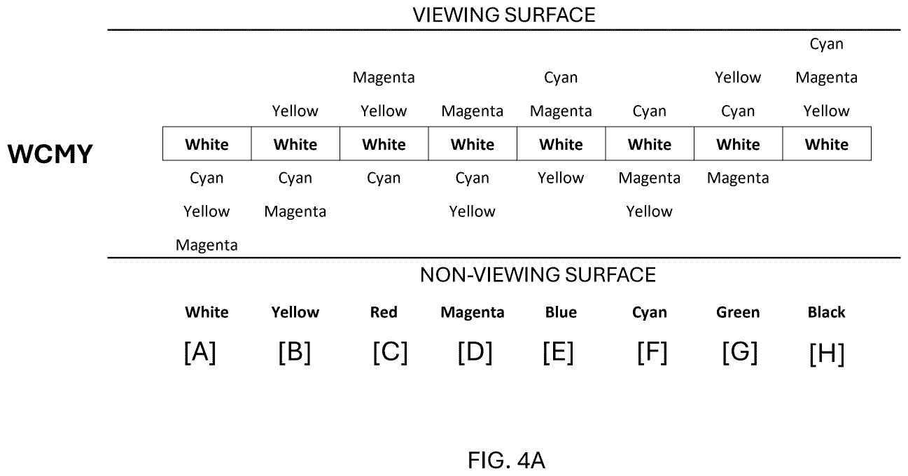

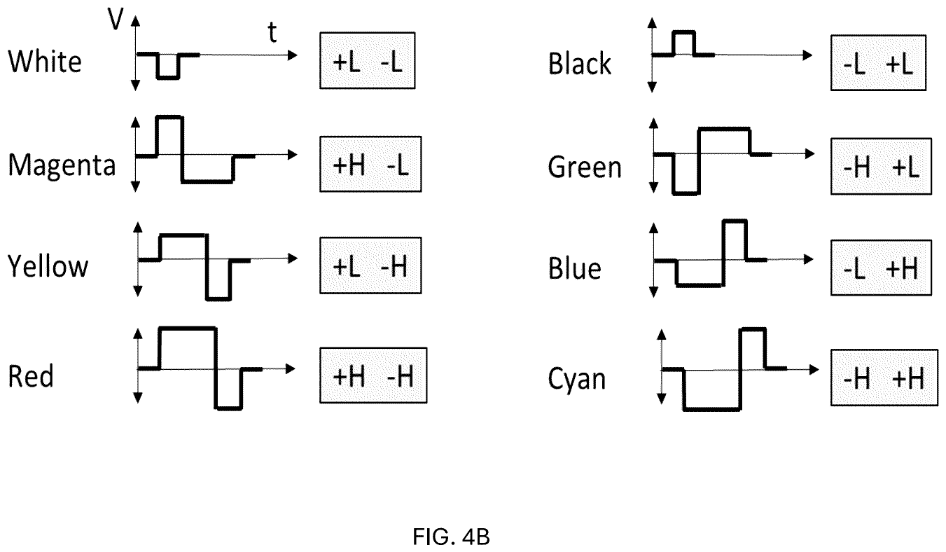

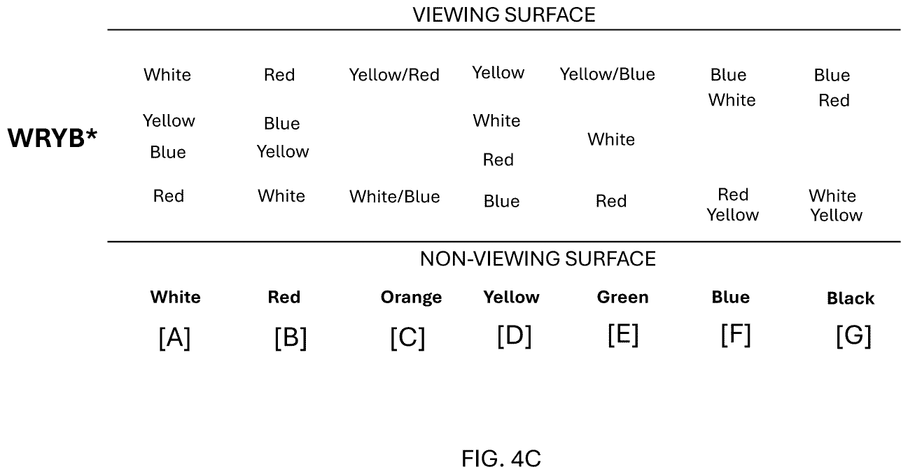

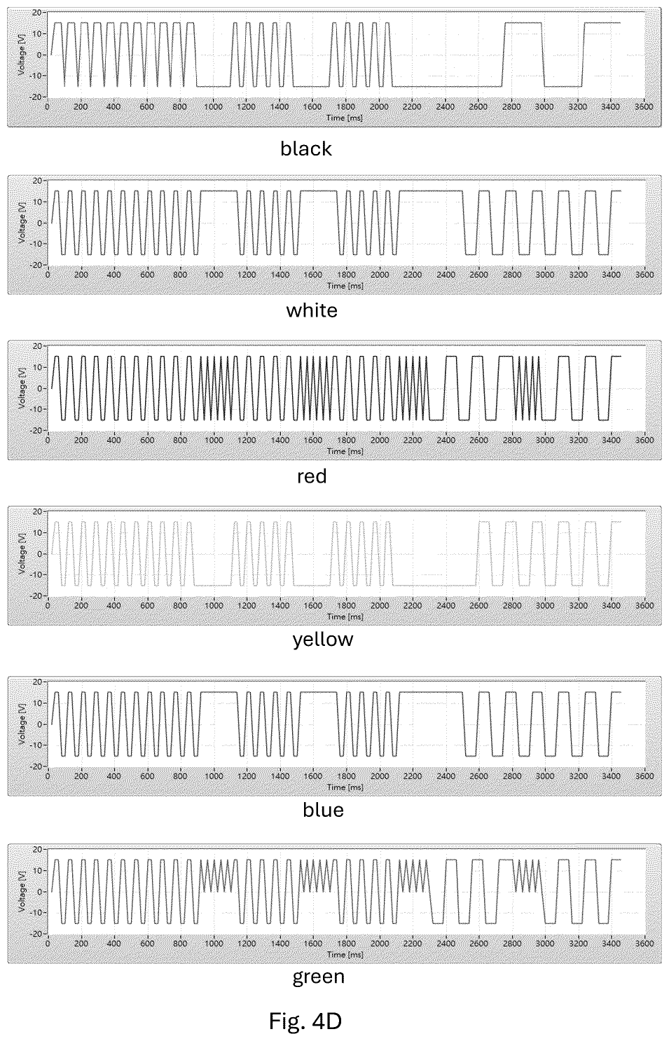

As discussed above, a color electrophoretic display may include a color filter array or an expanded particle system capable of producing all colors above each pixel electrode. As shown in FIG. 4A, in the instance of a four-particle system including subtractive cyan, yellow, and magenta particles paired with a reflective white particle, each of the eight principal colors (red, green, blue, cyan magenta, yellow, black and white) corresponds to a different arrangement of the four pigments. The three particles providing the three subtractive primary colors, e.g., for an Advanced Color electronic Paper (ACeP) display, may be substantially non-light-scattering (“SNLS”). The use of SNLS particles allows mixing of colors and provides for more color outcomes than can be achieved with the same number of scattering particles. These thresholds must be sufficiently separated relative to the voltage driving levels for avoidance of cross-talk between particles, and this separation necessitates the use of high addressing voltages for some colors. In addition, addressing the colored particle with the highest threshold also moves all the other colored particles, and these other particles must subsequently be switched to their desired positions at lower voltages.

The system of FIG. 4A, in principle, works similar to printing on bright white paper in that the viewer only sees those colored pigments that are on the viewing side of the white pigment (i.e., the only pigment that scatters light). In FIG. 4A, it is assumed that the viewing surface of the display is at the top (as illustrated), i.e., a user views the display from this direction, and light is incident from this direction. As already noted, in preferred embodiments only one of the four particles used in the electrophoretic medium of the present invention substantially scatters light, and in FIG. 4A this particle is assumed to be the white pigment. This light-scattering white particle forms a white reflector against which any particles above the white particles (as illustrated in FIG. 4A) are viewed. Light entering the viewing surface of the display passes through these particles, is reflected from the white particles, passes back through these particles and emerges from the display. Thus, the particles above the white particles may absorb various colors and the color appearing to the user is that resulting from the combination of particles above the white particles. Any particles disposed below (behind from the user's point of view) the white particles are masked by the white particles and do not affect the color displayed. Because the second, third and fourth particles are substantially non-light-scattering, their order or arrangement relative to each other is unimportant, but for reasons already stated, their order or arrangement with respect to the white (light-scattering) particles is critical.

More specifically, when the cyan, magenta and yellow particles lie below the white particles (Situation [A] in FIG. 4A), there are no particles above the white particles and the pixel simply displays a white color. When a single particle is above the white particles, the color of that single particle is displayed, yellow, magenta and cyan in Situations [B], [D] and [F] respectively in FIG. 4A. When two particles lie above the white particles, the color displayed is a combination of those of these two particles; in FIG. 4A, in Situation [C], magenta and yellow particles display a red color, in Situation [E], cyan and magenta particles display a blue color, and in Situation [G], yellow and cyan particles display a green color. Finally, when all three colored particles lie above the white particles (Situation [H] in FIG. 4A), all the incoming light is absorbed by the three subtractive primary colored particles and the pixel displays a black color. Because the order of the particles between the pixel electrode and viewer is critical, a pixel electrode that is not updated during a partial update can be disturbed by a neighboring pixel that is being updated. Furthermore, the resulting color shift may not be predictable because the highest charged particles, typically cyan, move the most due to inter-pixel coupling.

FIG. 4B shows typical waveforms (in simplified form) used to drive a four-particle WCMY electrophoretic display system described above from a neutral starting state, i.e., where all of the particles are evenly distributed in the electrophoretic medium. Such waveforms have a “push-pull” structure: i.e., they consist of a dipole comprising two pulses of opposite polarity. Typically, each dipole has a pulse of voltage V₁ applied for a time t₁ followed by a voltage V₂ applied for time t₂. The dipole is impulse balanced when V₁t₁+V₂t₂=0. The magnitudes and lengths of these pulses determine the color obtained. At a minimum, there should be five such voltage levels. FIG. 4B shows high and low positive and negative voltages, as well as zero volts. Typically, “low” (L) refers to a range of about 5-15V, while “high” (H) refers to a range of about 15-30V. In general, the higher the magnitude of the “high” voltages, the better the color gamut achieved by the display. In some instances, especially where more colors are required, medium voltages are also included. The “medium” (M) level is typically around 15V; however, the value for M will depend somewhat on the composition of the particles, as well as the environment of the electrophoretic medium. To properly address the medium from a neutral state the push-pull waveform is typically provided multiple times.

An alternative particle set using reflective color particles is shown in FIG. 4C. In the embodiment of FIG. 4C, the reflective particles are white, red, and yellow, and they are combined with a semi-transparent blue, however alternative color sets could be used provided that the combination of colors suitably spanned the useful color spectrum. In the system of FIG. 4C, for white, red, and yellow, the color viewed at the surface is due to direct reflection of the colored particles; for orange it is a mixture of red and yellow reflective pigments. For green, blue, and black at the viewing surface, the colors at the viewing surface are due to mixtures of the semi-transparent blue particle with reflective yellow, white, and red particles, respectively. Because a viewer is looking at light that is predominantly only interacting with one pigment surface, images produced with a system of FIG. 4C appear more saturated than the colors of FIG. 4A. However, the overall gamut of colors using a system of FIG. 4C is diminished as compared to those of FIG. 4A because it is difficult to achieve fine control of the amount of specific particles that are mixed together to create secondary colors (e.g., orange, green, violet). In applications such as digital signage, the saturation is often more important than the color gamut, and many users are satisfied with a set of seven or eight “standard” colors. It should also be realized with respect to FIG. 4C, that the reflective red and semi-transparent blue particles can switch roles, i.e., to make an electrophoretic display medium including reflective white, yellow, and blue particles and a semi-transparent red particle. Such a system yields a set of primary colors similar to FIG. 4C, but wherein red at the viewing surface results from a combination of semi-transparent red and white. Because the system of FIG. 4C includes mostly reflective particles, electrophoretic displays including this medium are less influenced by inter-pixel coupling. However, the methods of the invention can still be used with these systems.

FIG. 4D illustrates six exemplary (normal) waveforms for driving a system with reflective white, red, and yellow particle sets and a semi-transparent blue particle set to produce color states of black, white, red, yellow, blue, and green, respectively, from top to bottom, from a prior color state, which could be a neutral color state, i.e., where the reflective white, red, and yellow particle sets and a semi-transparent blue particles are equally mixed. Importantly, each of the waveforms shown in FIG. 4D includes a shaking pulse at the beginning, which helps the mixture of charged particles to reach the correct neutral state from which the electrophoretic medium can be addressed to achieved a desired color state. For the system described in FIG. 4D, if the shaking is foregone, the end colors will drift because the waveform drive instructions assume a particular starting state. Unfortunately, the required shaking pulses dramatically add to the “flashiness” of the updates as the white particles, in particular, are driven to the viewing surface and then away multiple times.

For example, the black waveform at the top of FIG. 4D includes four series of positive and negative voltage pulses alternating between +15V and −15V (dashed box). That is, the pulses have peak heights of +15V and −15V. However, the peak height is not limited to 15V of magnitude and it could be larger, such as ±100V, or smaller, such as ±5V, or anywhere in between. For embodiments where the back electrode is independently-controllable, there are fewer limitations on peak height because a power supply suitable for producing a given peak voltage can typically be acquired or purchased. However, it is more typical for the voltages used to be between +10V and +40V and between −10V and −40V. In some embodiments, some of the pulses have a peak width of 15 ms or greater, such as 60 ms or 20 ms, i.e., between 15 ms and 200 ms.

FIG. 4D also shows exemplary waveforms to producing white, red, yellow, blue, and green optical states. Each of the waveforms of FIG. 4D comprises at least three series of alternating positive and negative voltage pulses having a given peak height and a given pulse width. In most cases, the shaking voltage pulses are separated by a single pulse having a pulse width greater than the given pulse width.

Different combinations of light scattering and light absorbing particle sets are also possible. For example, one subtractive primary color could be rendered by a particle that scatters light, so that the display would comprise two types of light-scattering particle, one of which would be white and another colored. In this case, however, the position of the light-scattering colored particle with respect to the other colored particles overlying the white particle would be important. For example, in rendering the color black (when all three colored particles lie over the white particles) the scattering colored particle cannot lie over the non-scattering colored particles (otherwise they will be partially or completely hidden behind the scattering particle and the color rendered will be that of the scattering colored particle, not black). Of course, it would not be easy to render the color black if more than one type of colored particle scattered light without the presence of an absorptive black particle.

FIGS. 4A-4D show idealized situations in which the colors are uncontaminated (i.e., the light-scattering white particles completely mask any particles lying behind the white particles in FIG. 4A, or the selected reflective particles shield all of the other particles that should not be visible in FIG. 4C). In practice, the masking by the white particles may be imperfect so that there may be some small absorption of light by a particle that ideally would be completely masked. Such contamination typically reduces both the lightness and the chroma of the color being rendered. In the instance of FIG. 4C, the presence of the light-absorbing particles often causes the overall image to look darker due to imperfect scattering of the reflective particles. This is particularly problematic for green hues because the human eye is very sensitive to different shades of green, whereas different shades of red are not as noticeable. In some embodiments, this can be corrected with the inclusion of additional particles with different steric or charge characteristics, e.g., a green scattering particle, however adding additional particles complicates the drive scheme and may require a wider range of driving voltages. Obviously, in the electrophoretic media described herein, such color contamination should be minimized to the point that the colors formed are commensurate with an industry standard for color rendition. A particularly favored standard is SNAP (the standard for newspaper advertising production), which specifies L*, a* and b* values for each of the eight primary colors referred to above.

Waveforms for driving four-particle electrophoretic media have been described previously. Waveforms for driving color electrophoretic displays having four particles are described in U.S. Pat. Nos. 9,921,451, 9,812,073, and 11,640,803, all of which are incorporated by reference herein. Most commercial electrophoretic displays use amorphous silicon based thin-film transistors (TFTs) in the construction of active-matrix backplanes (260) because of the wider availability of fabrication facilities and the costs of the various starting materials. Amorphous silicon thin-film transistors may become unstable when supplied gate voltages that would allow switching of voltages higher than about +/−15V. Accordingly, as described in previous patents/applications on such systems, improved performance is achieved by additionally changing the bias of the top light-transmissive electrode with respect to the bias on the backplane pixel electrodes, a technique known as top-plane switching. Thus, if a voltage of +30V (relative to the backplane) is needed, the top plane may be switched to −15V while the appropriate backplane pixel is switched to +15V. Methods for driving a four-particle electrophoretic system with top-plane switching are described in greater detail in, for example, U.S. Pat. No. 9,921,451. In alternative embodiments, metal oxide semiconductors may be incorporated into thin film transistors for active-matrix backplanes (260), including IGZO, i.e., as described in U.S. Pat. No. 11,776,496, which is incorporated by reference in its entirety.

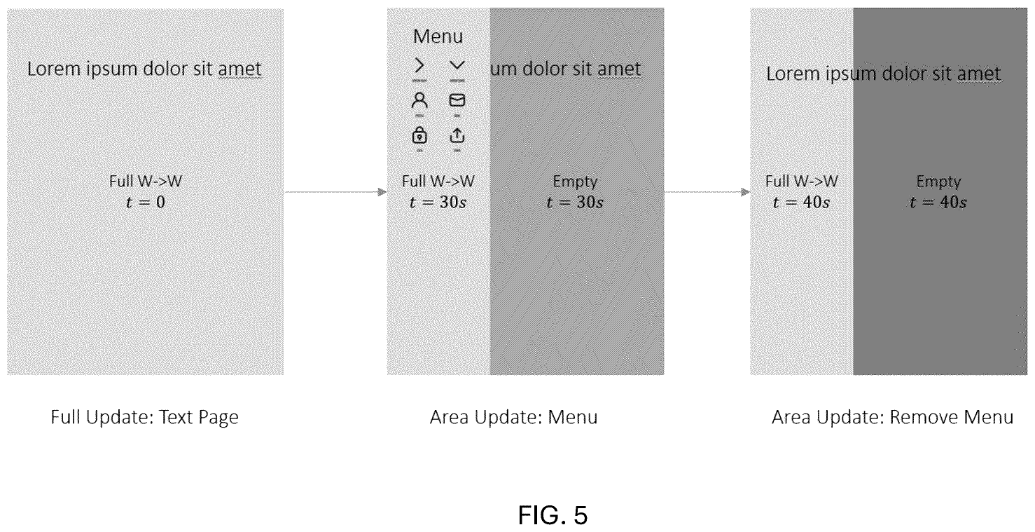

FIG. 5 illustrates the problems that can arise because of color state drift. Such color shift is typically seen during partial updates, REGAL-style updates (designed to defeat edge ghosting), area updates (typically caused by pull-down menus), and video driving, especially for cartoons where large portions of the background may not change for many frames. FIG. 5 shows a screen update at time (t)=0, and then an area update in only one section of the screen at t=30 s. Because only the left-hand portion of the display was updated, the right-hand side of the screen will appear to have a different optical state, even though they should be identical.

If the white state is drifting at a rate in which the difference between the 30 s white state and the 0 s white state is perceptibly different, then an apparent difference will be visible to the user between the two regions of the screen that are supposed to be the same. Depending on the level of drift, this issue may be more or less perceptible. It is normal for users to attempt area updates within a few minutes of doing a full update in normal user interface usage. Using the described methods will reduce the magnitude of the color shift such that the user does not see white states that are at different points in their drift dynamics over time. In principle any of these white states can be displayed on the display panel at the same time next to each other, exposing a perceptible difference.

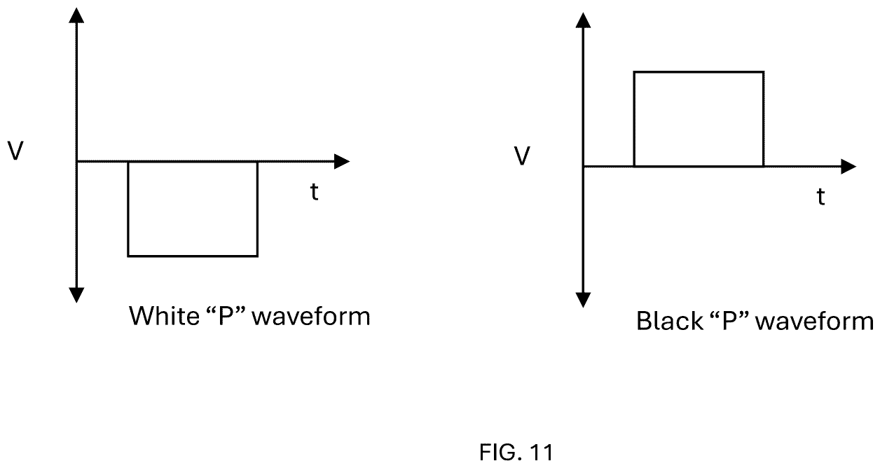

One method to remove the color drift is to apply a special “push” or “P” waveform on regions of the screen that were updated more than N seconds ago when a new update is queued, whether on the whole screen or on an area of the screen. N seconds may be 2, 3, 5, 8, 10, 13, 15, 20, 25, 30, 40, or 43 seconds or longer. The method of applying these “push” or “P” waveforms is also known colloquially as “stomp mode” or the “stomp” algorithm”. Exemplary white P waveforms and exemplary black P waveforms for the system of FIGS. 4A and 4B are shown in FIG. 11. While the P waveforms (a.k.a. update waveforms, generally) are of the same general shape as the driving waveforms of FIG. 4B, they typically provide less impulse that the “regular” drive waveforms, i.e., by being of a smaller voltage than the regular waveforms or being of a small voltage than the regular waveforms, or both. P waveforms for all of the color states can be similarly achieved.

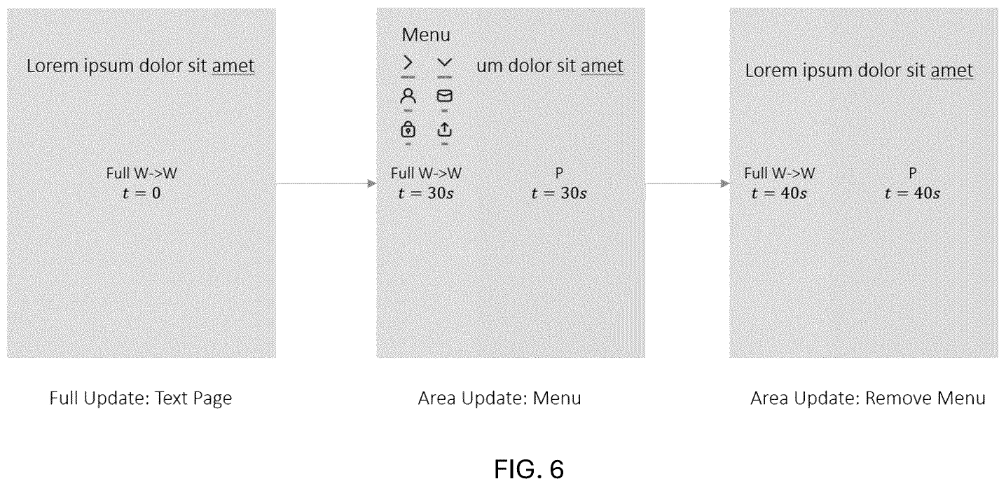

In this scheme, depending on the time threshold chosen, an area update which applies the white->white transition will also trigger a second update in which the white pixels of the rest of the display will undergo a custom transition that is meant to set the white state back to the 0 s white state, or as close as possible within the constraints. Applying the P waveform to the drifted portions of the display area in FIG. 5 is illustrated in FIG. 6. In some embodiments, the processor provides a time threshold for applying P waveforms for color state correction. The time threshold may be, for example, pixels that have not been updated for 2 seconds or more, for example 5 seconds or more, for example 10 seconds or more, for example 15 seconds or more, for example 20 seconds or more, for example 30 seconds or more.

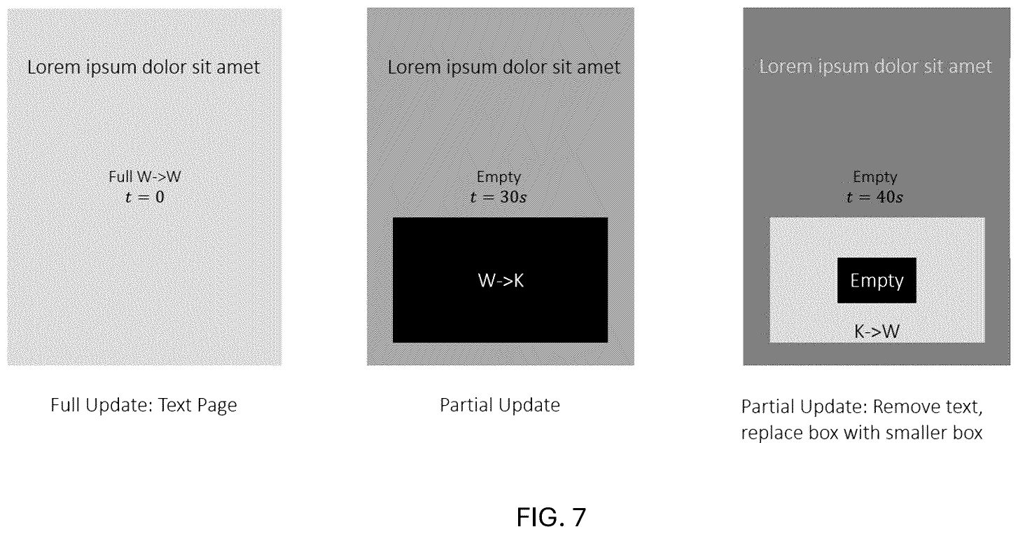

Another embodiment relates to the use of partial updates during the course of transitioning between images, whether it be between pages of a book, webpages, or frames of a video. A partial update is one in which the self-to-self transition in the waveform transition matrix are empty or do not drive with any voltage. For example in this case, any pixels that are in the white state will not flash or apply the voltage in the waveform transition matrix specified by the W->W transition. This is another use case in which the drift can expose issues to the user. An example of color shift during partial updating is shown in FIG. 7. As in FIG. 5, some amount of color shift becomes perceivable between the pixels that were, and were not, updated during the image update.

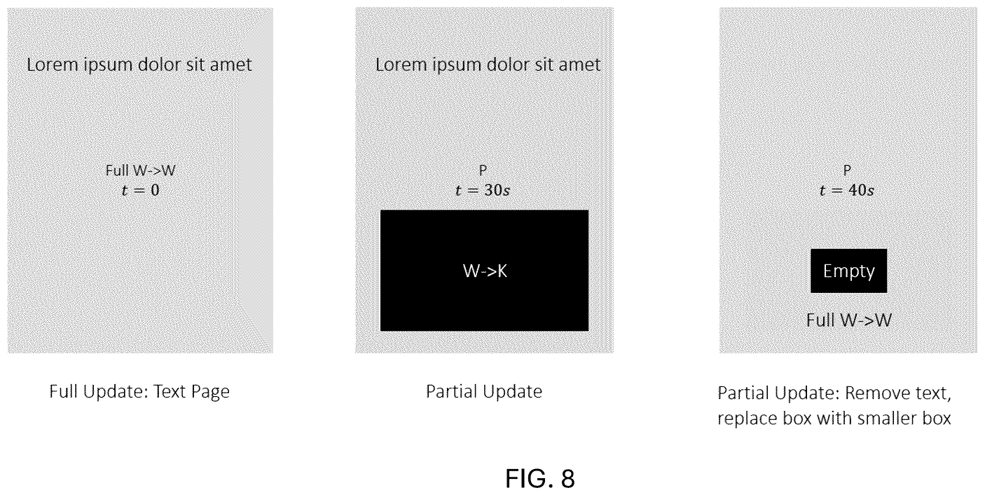

Similarly, as shown in FIG. 8, the P transition can be applied to pixels that were not updated during the partial update and are to remain white to minimize the impact of the color drift. A practical method of implementing this scheme for area updates that does not block the rest of the display from applying other updates for an unreasonable amount of time is to generate a different waveform mode in which only the “P” transition is contained. Since the “P” transition is typically much shorter than the normal W->W update, this can be placed in a separate update for the other areas of the display in which it is required. This minimizes the amount of time that the rest of the display is blocked from performing other updates. Of course, the method can be extended to any/all states by developing unique push “P” transitions for each of the color states. For example, in a user interface implementation in which the background is in black and there is significant drift in the black state, the same scheme could be used with a PK transition instead. PR may be used to address red state color drift, etc.

Additionally, when used on a color display or CFA (color filter array)-based display where dithered content will be present, it would be possible to detect regions of dithered content and prevent applying the “P” transition in those areas to minimize the impact to image quality by selectively applying it within dithered content. Because of interpixel interactions, the use of this transition could modify the appearance of dithered images. To avoid this detrimental effect, we can define an M×N kernel in which all pixels in the M×N rectangle must be in the particular state we are planning to apply the P transition to. For example, we can apply a convolutional kernel of an N×N square that counts the number of pixels that are in W and only applying the P transition when all neighbors in a 3×3 grid are also W:

$$i m ( x , y ) {K}_{3 \times 3} == 9 , apply P \qquad ( 1 )$$

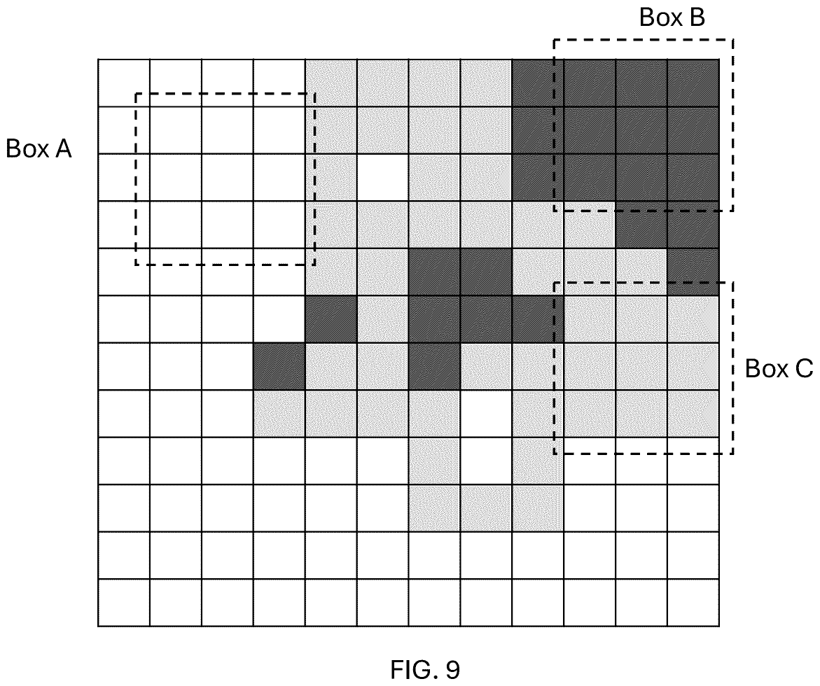

Thus, the impact in dithered content can be minimized by use of the above convolutional kernel. The concept is exemplified in FIG. 9, illustrating when a kernel of the appropriate size is detected, amongst an image or a dither pattern, the P transition is applied. For a section of a dithered image, if the N×N convolutional kernel is set for 3×3, only groups of same optical states that are at least 3×3 will receive a P transition, while other portions of the dither pattern, including same optical state pixels that are not part of at least a 3×3 grouping will not receive a P transition. Of course, the kernel need not be square and can be M×N, generally. The total number of pixels within the update area is arbitrary but is typically at least a 3×3 square, i.e., 9 pixels. The total number of pixels in the identified region may be larger, such as 16, 25, 36, 49, 64, 81, or 100 pixels or more. The concept can be visualized by the bounding boxes A, B, and C in FIG. 9, whereby a grouping of white pixels (Box A) will receive a P transition for the white state, a group of dark gray pixels (Box B) will receive a P transition for the dark gray state, and a group of light gray pixels (Box C) will receive a P transition for the light gray state. In this way, singular pixels of different colors will not be updated, which often results in a dithered area appearing to change color. Of course, the convolutional kernel is somewhat arbitrary, and it can be set at any M×N rectangle, however, N×N squares typically work better. The N×N square can be, for example, 3×3, 5×5, 10×10, 25×25, 50×50, or 100×100 pixels.

Because pixels can be updated at different times on this display, many times with less than the threshold number of seconds between updates, the controller can determine whether or not to run the algorithm on the whole display by keeping track of the timestamp of the last time the algorithm and/or full update (GC, STRD, FAST, without partial updating). If this time exceeds the threshold, the controller will apply the method to remove any potential color state drift. The controller can remove all of the color state drift for a give optical state at the same time, however, it is less noticeable when different portions of the display having the same optical state receive P transitions are done in a sequential fashion.

### Example

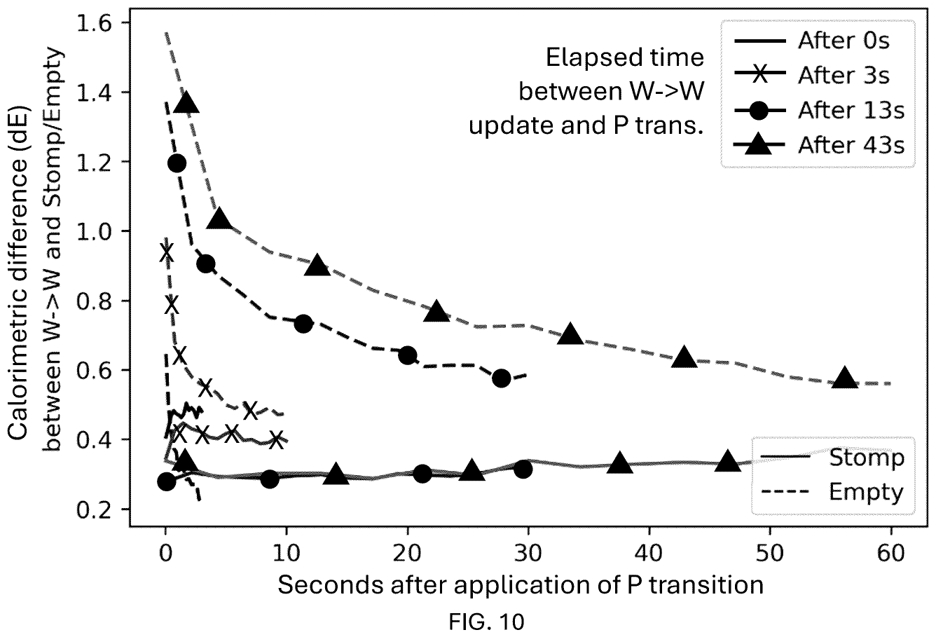

FIG. 10 shows a simulation of the shift in color states for various white->white updates coupled with “P” transition waveforms (“Stomp”) compared to the same white->white update without the “P” transitions (“Empty”). The legend indicates the elapsed time between the W->W update and application of the “P” transition waveforms. The x-axis indicates the elapsed time since the P transition was applied. Comparing the methods shows that the colorimetric difference can be greater than 1 L* (perceptible to the human eye) if the white state is updated after 13 seconds. This difference can persist for tens of seconds before decaying to an imperceptible level (dashed lines-Empty-no P transitions). By applying the “P” transition, the differences between a W->W update and the “P” applied section become reduced significantly (solid lines). Thus, the described methods will improve the user experience in some instances in an electrophoretic display.

Having thus described several aspects and embodiments of the technology of this application, it is to be appreciated that various alterations, modifications, and improvements will readily occur to those of ordinary skill in the art. Such alterations, modifications, and improvements are intended to be within the spirit and scope of the technology described in the application. For example, those of ordinary skill in the art will readily envision a variety of other means and/or structures for performing the function and/or obtaining the results and/or one or more of the advantages described herein, and each of such variations and/or modifications is deemed to be within the scope of the embodiments described herein. Those skilled in the art will recognize or be able to ascertain using no more than routine experimentation, many equivalents to the specific embodiments described herein. It is, therefore, to be understood that the foregoing embodiments are presented by way of example only and that, within the scope of the appended claims and equivalents thereto, inventive embodiments may be practiced otherwise than as specifically described. In addition, any combination of two or more features, systems, articles, materials, kits, and/or methods described herein, if such features, systems, articles, materials, kits, and/or methods are not mutually inconsistent, is included within the scope of the present disclosure.

1. A method for reducing color drift in an electrophoretic display undergoing a partial update, wherein the electrophoretic display includes an active matrix of pixel electrodes, the method comprising:
identifying an M×N matrix of pixels that were not updated in a first partial update and remain in a first optical state between the time of the first partial update and a later time that is at least 3 seconds after the first partial update;
sending an update waveform for the first optical state to each pixel of the M×N matrix of pixels in order to reduce color drift in the electrophoretic display; and
sending no waveform to pixels that were not updated in the first partial update and remain in the first optical state between the time of the first partial update and the later time that is at least 3 seconds after the first partial update but were not included in the identified M×N matrix of pixels.

2. The method of claim 1, wherein the update waveform for the first optical state is shorter in length than a standard waveform for a transition from a neutral state to the first optical state.

3. The method of claim 1, wherein the first optical state is a white optical state.

4. The method of claim 1, wherein the M×N matrix of pixels includes at least 9 pixels.

5. The method of claim 1, further comprising:
after sending an update waveform to each pixel of the M×N matrix of pixels,
identifying a different M′×N′ matrix of pixels that were not updated in the first partial update and remain in the first optical state between the time of the first partial update and a later time that is at least 3 seconds after the first partial update; and
sending an update waveform for the first optical state to each pixel of the M′×N′ matrix of pixels.

6. The method of claim 5, wherein the M×N matrix of pixels is larger than the M′×N′ matrix of pixels.

7. The method of claim 1, further comprising:
after sending an update waveform to each pixel of the M×N matrix of pixels,
identifying a different M′×N′ matrix of pixels that were not updated in the first partial update and which remain in a second optical state between the time of the first partial update and a later time that is at least 3 seconds after the first partial update; and
sending an update waveform for the second optical state to each pixel of the M′×N′ matrix of pixels.

8. The method of claim 7, wherein the M×N matrix of pixels is the same size as the M′×N′ matrix of pixels.

9. The method of claim 1, wherein at least a portion of the electrophoretic display shows a dithered image before the first partial update.

10. The method of claim 7, wherein at least a portion of the electrophoretic display shows a dithered image before the first partial update, and the dithered image includes pixels of the first optical state and the second optical state.

11. The method of claim 7, wherein the first optical state is a white optical state and the second optical state is a nonwhite optical state.

12. The method of claim 11, wherein the second optical state is a black optical state.

13. The method of claim 1, wherein the electrophoretic display comprises an electrophoretic medium including electrically charged particles dispersed in a fluid and confined within a plurality of capsules or microcells.

14. The method of claim 13, wherein the electrophoretic medium includes four different types of electrically charged particles, and at least two of the types of electrically charged particles have opposite polarities.

15. The method of claim 14, wherein the electrophoretic medium includes two positive electrically charged particles and two negative electrically charged particles or three positive electrically charged particles and one negative electrically charged particle or one positive electrically charged particle and three negative electrically charged particles.

16. The method of claim 2, wherein the first optical state is a white optical state.
